(19) United States
(12) Patent Application Publication
(10) Pub. No.: US 2011/0274126 A1
(43) Pub. Date: Nov. 10, 2011

(54) METHOD OF SWITCHING LASER EMISSION OF A SOLID STATE LASER BETWEEN DIFFERENT EMISSION WAVELENGTHS AND CORRESPONDING SOLID STATE LASER DEVICE

(75) Inventors: Lucia Bonelli, Pisa (IT); Jaione Bengoechea Apezteguia, Arraioz (ES); Ulrich Weichmann, Aachen (DE)

(73) Assignee: KONINKLIJKE PHILIPS ELECTRONICS N.V., EINDHOVEN (NL)

(21) Appl. No.: 13/146,408

(22) PCT Filed: Jan. 25, 2010
(86) PCT No.: PCT/IB2010/050318

§ 371 Date: Jul. 27, 2011

(30) Foreign Application Priority Data
Jan. 28, 2009 (EP) 09151513.0

(51) Int. Cl. H01S 3/105; H01S 3/086

(52) U.S. Cl. 372/20

(57) ABSTRACT

The present invention relates to a method of switching laser emission of a solid state laser between different emission wavelengths, said different emission wavelengths being based on different electronic transitions in a solid state laser medium (3) of the solid state laser. The at least two end mirrors (1, 2) of the solid state laser are designed to allow lasing of the laser at the different emission wavelengths and coupling out of the different emission wavelengths at one end mirror (2) of the laser cavity. The switching of the laser emission is achieved by switching the cavity length of the laser cavity between different cavity lengths, wherein the different cavity lengths are selected such that at each of the cavity lengths the solid state laser lases at only one of the different emission wavelengths which is different from the emission wavelengths at the other of the selected cavity lengths. With the method and corresponding device an easy switching between emission wavelengths of a solid state laser is possible.

### FIELD OF THE INVENTION

The present invention relates to a method of switching laser emission of a solid state laser between different emission wavelengths, said different emission wavelengths being based on different electronic transitions in a solid state laser medium of the solid state laser. The invention also comprises a solid state laser device switchable between different emission wavelengths according to the method.

In the last years the interest on the development of new solid state lasers emitting in the visible wavelength region is increased. In fact these laser sources could be useful in the development of a new generation of color displays, new data storage techniques, holographic techniques, calibration stars for astrophysical experiments, and also in biomedical application tasks and other technical fields. Once solid state lasers emitting in blue, green and red are available, they can e.g. replace UHP lamps in projection.

Due to its electronic configuration, the Pr³⁺-ion is one of the most promising candidates amongst the rare earth ions as the activator in a blue diode pumped solid-state laser. The Pr³⁺-ion shows significant absorption at the blue wavelength and can convert this radiation into laser emission at cyan, green, red and orange wavelengths. This fact permits to project laser radiation at different visible wavelengths from the same active medium.

### BACKGROUND OF THE INVENTION

Laser action of Pr³⁺-ions at room temperature has been demonstrated in YAlO₃, but the best results have been obtained in fluoride materials in both the pulse and the cw regime. Due to the low phonon energy of the fluorides, the ³P₀ level, which is the upper level for visible laser emission, is not quenched by non-radiative relaxation. The first laser experiments used a Xe flashlamp, dye- or Ar⁺-lasers as pumping sources. Recently the development of solid-state technology has enhanced the emission using laser diodes or optically pumped semiconductor laser (OPS) as pumping sources.

Visible laser transitions in Pr³⁺-ions are often obtained in two principal ways: using Pr³⁺/Yb³⁺-codoping with pumping in the infrared region or pumping directly the ³P₀ manifold of the Pr³⁺-ion. Upconversion emission due to the avalanche excitation process in Pr³⁺/Yb³⁺ has been used to obtain visible emission under infrared pumping. Laser oscillation in the red spectral range was reported in Pr³⁺/Yb³⁺:LiYE₄ crystals and Pr³⁺/Yb³⁺:ZrF₄,BaF₂,LaF₃,AlF₃,NaF₃ (ZBLAN) glass. Red and orange laser oscillation has been presented for a Pr³⁺/Yb³⁺:BaY₂F₈ under infrared excitation. Pumping directly the ³P₀ level with an OPS, laser emission at 640 nm, 721 nm, 607 nm and 522 nm from a single Pr³⁺-doped LiLuF₄ crystal has also been demonstrated.

The different laser wavelengths emitted are obtained separately using proper output couplers, having high reflectivity at the lasing wavelength. It is however highly desirable to obtain more than one wavelength from a single laser device for many different applications. Especially a device that allows for a switching between different emission wavelengths would be of great use.

DE 3730563 C2 describes a Nd:YAG solid state laser switchable between two different emission wavelengths which are based on different electronic transitions of the Nd:YAG solid state laser medium. In this device, two different outcoupling mirrors of the laser cavity are provided at different positions for the different emission wavelengths. One of these outcoupling mirrors is designed to be totally reflective for one of the emission wavelengths which has a lower gain, and to be transmissive for the other emission wavelength. The second outcoupling mirror is arranged behind the first outcoupling mirror and designed to be highly reflective for the second emission wavelength. By blocking or opening the beam path between the two outcoupling mirrors the laser emission wavelength can be switched between the two emission wavelengths.

### SUMMARY OF THE INVENTION

It is an object of the present invention to provide a method of switching laser emission of a solid state laser between different emission wavelengths, which are based on different electronic transitions in a solid state medium of the solid state laser, and a corresponding solid state laser device switchable according to the method, the method and device allowing an easy and convenient switching between the different emission wavelengths with a simple switching mechanism.

The object is achieved with the method and device according to claims 1 and 6. Advantageous embodiments of the method and device are subject matter of the dependent claims or are described in the subsequent portions of the description.

In the proposed method a solid state laser is provided with at least two end mirrors forming a laser cavity, wherein said end mirrors are designed to allow lasing of the laser at the different emission wavelengths and coupling out of the different emission wavelengths at one end mirror of the laser cavity. The solid state laser medium is obviously also selected to allow lasing at the different electronic transitions corresponding to the different emission wavelengths when optically or electronically pumped. As already known in the art, the end mirrors of the laser cavity must have a sufficiently high reflectivity for the different emission wavelengths to enable lasing, wherein one of these mirrors also allows transmission of a small portion of the laser emission for outcoupling. In the proposed method, the cavity length of the laser cavity is switched between different cavity lengths. This may be achieved by moving at least one of said end mirrors between different positions or by any other technique to change the optical cavity length, e.g. by rotating a glass plate in the beam path within the cavity or by changing the index of refraction of an appropriate element, like a liquid crystal element, in the beam path within the cavity. The different cavity lengths are selected such that at each of said different cavity lengths the solid state laser lases at only one of said different emission wavelengths, said one emission wavelength being different from the emission wavelengths at the other of said different cavity lengths. This means that at each of the selected different cavity lengths which are adjusted according to the method, the solid state laser lases at a different emission wavelength. The corresponding cavity lengths which are appropriate for this lasing at the different emission wavelengths can easily be found by a spectroscopic measurement of the output of the laser during tuning of the cavity length or movement of the corresponding end mirror.

The corresponding solid state laser device comprises at least two end mirrors forming the laser cavity, wherein said end mirrors are designed to allow lasing of the laser at the different emission wavelengths and coupling out of the different emission wavelengths at one end mirror of the laser cavity, and a solid state laser medium arranged in the laser cavity, wherein said different emission wavelengths are based on different electronic transitions in the solid state laser medium. The solid state laser device further comprises an actuator arranged to change the cavity length of the laser cavity, and a control unit designed to control the actuator to change the cavity length between different cavity lengths. The different cavity lengths are defined such that at each of the different cavity lengths the solid state laser lases at only one of the different emission wavelengths which is different from the emission wavelengths at the other of the different cavity lengths. Furthermore, a pump light source is arranged to optically pump the solid state laser medium.

In a preferred embodiment, the actuator is arranged to move at least one of the end mirrors to change the cavity length, and the control unit is designed to control the actuator to move the corresponding end mirror(s) between different positions, which different positions correspond to the different cavity lengths. The control unit may be an electrical or mechanical component.

With the proposed method and device the switching between the different emission wavelengths is simply achieved by small changes of the cavity length. The cavity length change can for example be achieved in a very simple way by a piezoelectric element which can be electrically controlled. The invention therefore provides a possibility to obtain two or more different lasing wavelengths using the same laser setup and changing only the length of the laser cavity of a solid state laser. The switching mechanism which relies on small changes of the cavity length can easily be achieved also with other appropriate actuators. By appropriately selecting the solid state laser medium switching of laser emission between green and red wavelengths can be achieved. Such laser wavelengths are suitable for laser displays, for example. Therefore, by using such a technologically advanced, yet simple switchable laser device as a projection light source, functionality of the projector optics, like the color wheel, are integrated into the laser source itself, leading to much simpler and more compact projector setups. Generally, the proposed method and solid state laser device can be used in any application, in which switchable laser emission is required. Such applications are for example in the visible region the generation of color displays, new data storage techniques, holographic techniques, calibration stars for astrophysical experiments and also biomedical application tasks.

In an advantageous embodiment, the solid state laser medium is formed of a Pr³⁺-doped host material, in particular a Pr³⁺:YLF crystal. This solid state laser medium can be pumped by a laser diode emitting in the blue wavelength region.

Nevertheless other possible candidates as the host crystal for visible laser applications based on Pr³⁺-emission are well known to the experts in the field and could for example be: LiYF₄, LiLuF₄, K₂YF₅, KY₃F₁₀, KYF₄, LiKYF₅, LiKGdF₅, LiCaAlF₆, LiSrAlF₆, LiGdF₄, ZBLAN, CaF₂, SrF₂, YF₃, CsY₂F₇, CsGs₂F₇, BaF₂, BaMgF₄, BaY₂F₈, LaF₃, CeF₃, PrF₃, LiPrP₄O₁₂, KY(MO₄)₂, KY(WO₄)₂, KGd(WO₄)₂, Ca(NbO₃)₂, CaWO₄, SrMoO₄, YAlO₃, LuAlO₃, SrAl₁₂O₁₉, Sr₃Al₂O₆, LaCl₃, LaBr₃, PrCl₃, PrBr₃.

### BRIEF DESCRIPTION OF THE DRAWINGS

The proposed method and device are described in the following by way of example in connection with the accompanying figures without limiting the scope of protection as defined by the claims. The figures show

FIG. 1 visible electronic transmissions of the Pr³⁺-ion;

FIG. 2 a schematical view of a laser resonator and pumping scheme of the device according to the present invention;

FIG. 3 dimensions and orientation of the solid state laser medium of FIG. 2;

FIG. 4 normalized acquired spectra for red and orange laser emission in POS1; and

FIG. 5 normalized acquired spectra for red and orange laser emission in POS2.

### DETAILED DESCRIPTION OF EMBODIMENTS

In the following an example of the method and device is shown in which a Pr³⁺:BaY₂F₈ crystal is used as the solid state laser medium and optically pumped by a laser diode emitting in the blue wavelength region. This exemplary solid state laser device is switched between red and orange laser emission at 640 nm and 609 nm respectively. It should be understood that the invention is not limited to this specific material or these two specific laser wavelengths. Other materials will allow for the same effect and by modifications of the reflectivities of the resonator end mirrors, switching between for example green and red laser emission is also possible.

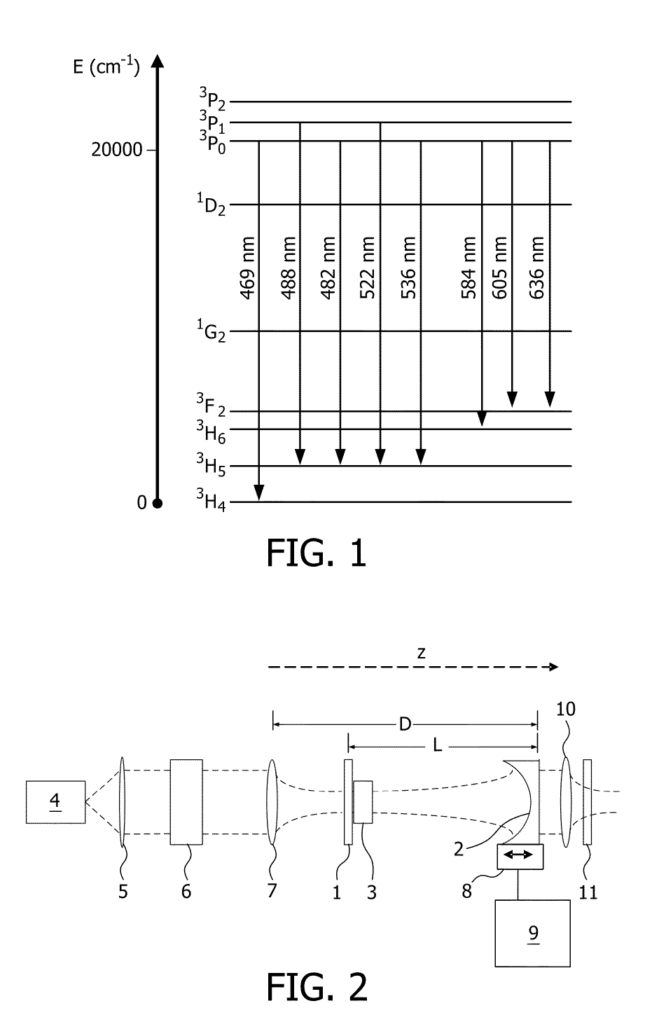

FIG. 1 shows the different visible electronic transitions of the Pr³⁺-ion which is a preferred candidate for the doping of the host material of the solid state laser medium. As can be seen from this figure, the Pr³⁺-ion allows transitions in the visible region, in particular in the cyan, green, red and orange wavelength range. Depending on the host material used, the indicated wavelengths are slightly shifted. Using, as in the present example, BaY₂F₈ as the host material, laser emission at 640 nm and 609 nm is possible.

FIG. 2 shows a schematic view of an exemplary setup of the proposed laser device. The laser cavity of the solid state laser is formed of two end mirrors; in this case an input flat mirror 1 and an out-coupling mirror 2. The input flat mirror 1 has a high transmission in the wavelength range of the diode pump laser 4 between 430 and 460 nm and a high reflectivity in the wavelength range between 605 nm and 650 nm. Out-coupling mirror 2 is a concave mirror with a radius of curvature of 50 mm. This mirror has a high reflectivity of R˜99% at 640 nm and of R˜98% at 609 nm. The solid state laser medium 3 is arranged at the beam waste of the laser cavity as indicated in FIG. 2. This solid state laser medium 3 is optically pumped by the diode pump laser 4 at 443 nm. The pump beam is shaped by an aspheric lens 5 having a focal length f of 6.2 mm, anamorphic prisms 6 and an achromatic lens 7 having a focal length f of 80 mm before entering the solid state laser medium 3 through the input flat mirror 1.

Out-coupling mirror 2 is mounted on a piezoelectric actuator 8, which is able to move this mirror in the direction of the optical axis of the laser cavity in order to change the cavity length L, which is the distance between input mirror 1 and out-coupling mirror 2. The piezoelectric actuator 8 is connected to a control unit 9 which controls the actuator to move the out-coupling mirror 2 between two positions which correspond to the two lasing wavelengths i.e. the red (640 nm) and orange (609 nm) laser emission.

In order to detect the red and orange laser emission a lens 10 of a focal length f=50 mm and a yellow filter 11 type GG495 with a thickness of 2 mm are arranged in the beam path of the laser emission behind the out-coupling mirror 2. To verify that only one laser wavelength (red or orange) was produced, a spectrometer was arranged behind the filter 11.

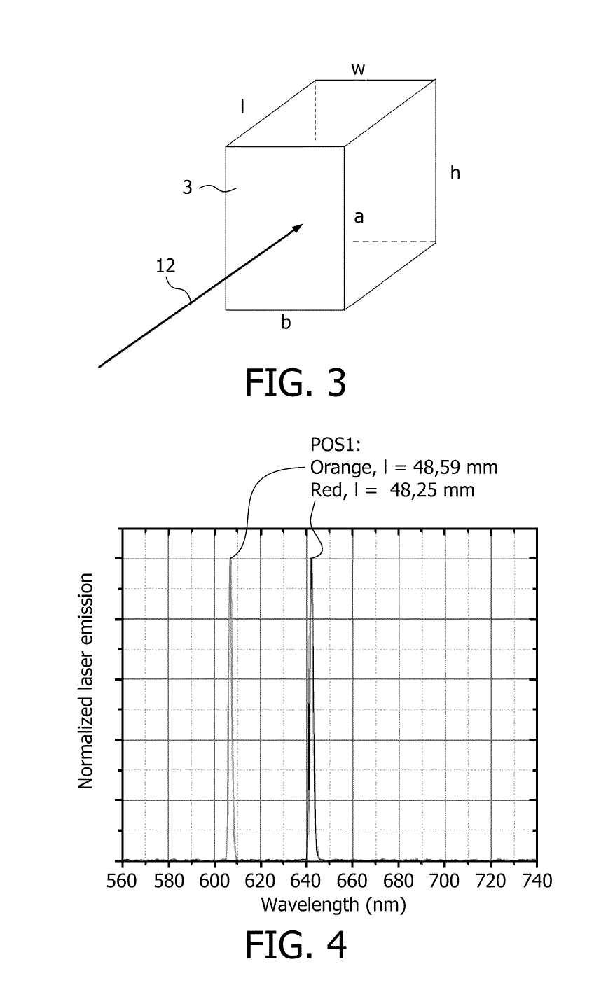

The solid state laser medium 3 used to obtain red and orange laser emission is a BaY₂F₈ crystal with 1.25% nominal Pr³⁺-doping. BaY₂F₂ is a monoclinic crystal. The crystallographic b-axis is the main symmetry axis and is perpendicular to the a-axis and c-axis. The a-axis and c-axis are not perpendicular to each other. In the present example this crystal was oriented and cut along the a- and b-axes. FIG. 3 shows the orientation of the crystal, i.e. the solid state laser medium 3, inside the laser cavity. The direction 12 of the pump laser beam is indicated. The dimensions of this solid state laser medium in the present example are 2.17×3.59×5.83 mm³ (w×h×l, see FIG. 3).

When aligning the laser cavity, laser emission can be observed at the orange and the red laser transition. This is due to the broad reflectivities of the resonator mirrors, which form a resonator or cavity for both wavelengths. The inventors of the present invention, however, while adjusting the resonator mirrors surprisingly found a configuration, where the laser operated at only one of the two transitions. In case of the present example two different geometrical setup configurations, in the following denoted as POS1 and POS2, where found in which the switching between red and orange is possible only by a small change in cavity length.

In the following the geometrical cavity parameters used to produce red and orange solid state pump laser emission by changing the cavity length maintaining the same components setup is described. In order to switch between the red and orange wavelength the out-coupling mirror 2 was moved along the z-direction indicated in FIG. 2. For the two geometrical setup configurations POS1 and POS2 the power, measured spectrum and geometrical setup parameters are shown in the following tables and figures.

In the POS1 configuration a cavity length of 48.25 mm was set and increased by a distance of 0.34 mm by moving out-coupling mirror 2 in the corresponding direction in order to switch from the red to the orange laser emission. Table 1 shows the cavity length L, the distance D between the out-coupling mirror 2 and the achromatic lens 7 and the power measured at the different lasing wavelengths. The normalized acquired spectra for the red and orange laser emission in configuration are depicted in FIG. 4.

TABLE 1

| | L | D | Power |
|---|---|---|---|
| | (mm) | (mm) | (mW) |
| Red | 48.25 | 125.92 | 19.0-22.6 |
| (640 nm) | | | |
| Orange | 48.59 | 126.26 | 8.5 |
| (609 nm) | | | |

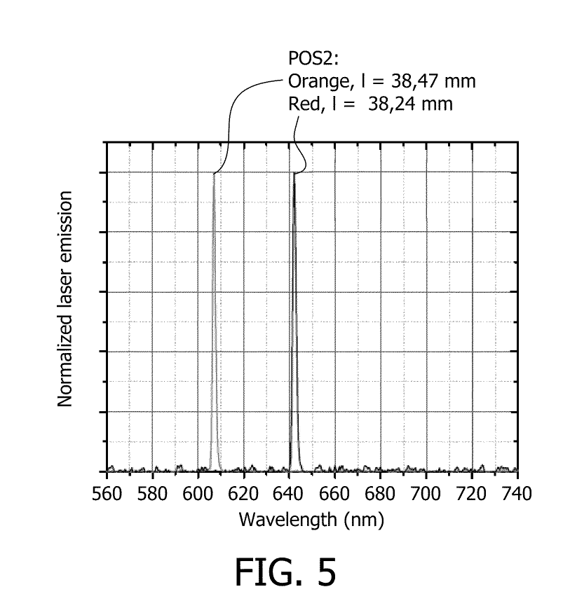

The same parameters and measurements are shown for the configuration POS2 which is different from the configuration of POS1 only by a different cavity length L of 38.24 mm for the red emission and 38.47 mm for the orange emission. This means that for switching from the red to the orange laser emission in this configuration, the cavity length is increased by a distance of 0.23 mm by accordingly moving the out-coupling mirror 2. Table 2 shows the corresponding geometrical parameters and measured output power, FIG. 5 shows the normalized acquired spectra for red and orange laser emission in this configuration.

TABLE 2

| | L | D | Power |
|---|---|---|---|
| | (mm) | (mm) | (mW) |
| Red | 38.24 | 117.69 | 12.9-13.6 |
| (640 nm) | | | |
| Orange | 38.47 | 117.92 | 2.1-3.9 |
| (609 nm) | | | |

In principal, the present invention is applicable also to other laser wavelengths. With an appropriate broad coating of the input mirror and out-coupling mirror, a single and integrated laser cavity can produce for example all the necessary colors for display applications. It should be mentioned that mirror coatings that allow for simultaneous green and red laser operation are feasible as well and will allow for switching between green and red laser emission.

While the invention has been illustrated and described in detail in the drawings and foregoing description, such illustration and description are to be considered illustrative or exemplary and not restrictive. The invention is not limited to the disclosed embodiments. The different embodiments described above and in the claims can also be combined. Other variations to the disclosed embodiments can be understood and effected by those skilled in the art in practicing the claimed invention, from the study of the drawings, the disclosure and the appended claims. For example, the change of the cavity length may also be achieved by moving the input flat mirror with an appropriate actuator. Furthermore, the cavity design may be different from that shown in FIG. 2, for example by using two curved end mirrors such that the beam waist and thus also the solid state laser medium are situated at a distance from the end mirrors.

In the claims, the word “comprising” does not exclude other elements or steps, and the indefinite article “a” or “an” does not exclude a plurality. The mere fact that measures are recited in mutually different dependent claims does not indicate that a combination of these measures cannot be used to advantage. The reference signs in the claims should not be construed as limiting the scope of these claims.

### LIST OF REFERENCE SIGNS

1 input flat mirror
2 outcoupling mirror
3 solid state laser medium
4 diode pump laser
5 aspheric lens
6 anamorphic prisms
7 achromatic lens
8 piezoelectric actuator
9 control unit
10 lens
11 yellow filter
12 pump beam direction

1. A method of switching laser emission of a solid state laser between different emission wavelengths, said different emission wavelengths being based on different electronic transitions in a solid state laser medium of said solid state laser, said method comprising:
providing the solid state laser with at least two end mirrors forming a laser cavity, said end mirrors being designed to allow lasing of the laser at the different emission wavelengths and coupling out of the different emission wavelengths at one end mirror of said laser cavity, and
switching a cavity length of said laser cavity between different cavity lengths, said different cavity lengths being selected such that at each of said different cavity lengths the solid state laser lases at only one of said different emission wavelengths which is different from the emission wavelengths at the other of said different cavity lengths.

2. The method according to claim 1, wherein the cavity length of said laser cavity is switched between different cavity lengths by moving at least one of said end mirrors different positions.

3. The method according to claim 2, wherein the laser emission is switched between two emission wavelengths by moving said at least one of said end mirrors between two different positions.

4. The method according to claim 1, wherein the solid state laser is provided with a solid state laser medium, which is formed of a Pr³⁺-doped host material.

5. The method according to claim 4, wherein the solid state laser is optically pumped by a laser diode emitting in the blue wavelength region.

6. A solid state laser device switchable between different emission wavelengths, comprising:
at least two end mirrors forming a laser cavity, said end mirrors being designed to allow lasing of the laser at the different emission wavelengths and coupling out of the different emission wavelengths at one end mirror of said laser cavity,
a solid state laser medium arranged in said laser cavity, said different emission wavelengths being based on different electronic transitions in said solid state laser medium,
a pump light source arranged to optically pump said solid state laser medium,
an actuator arranged to change a cavity length of said laser cavity, and
a control unit designed to control said actuator to change the cavity length between different cavity lengths, wherein the different cavity lengths are defined such that at each of said different cavity lengths the solid state laser lases at only one of said different emission wavelengths which is different from the emission wavelengths at the other of said different cavity lengths.

7. The device according to claim 6, wherein the actuator is arranged to move at least one of said end mirrors to change the cavity length and wherein the control unit is designed to control said actuator to move said at least one of said end mirrors between different positions, said different positions corresponding to said different cavity lengths.

8. The device according to claim 6, wherein the solid state laser medium is formed of a Pr³⁺ doped host material.

9. The device according to claim 6, wherein the solid state laser medium is formed of a Pr³⁺:YLF crystal.

10. The device according to claim 7, wherein the pump light source is a laser diode emitting in the blue wavelength region.

11. The device according to claim 6, wherein the end mirrors and the control unit are designed to switch the emission wavelength between an emission wavelength in the green wavelength region and an emission wavelength in the red wavelength region.

12. The device according to claim 6, wherein said actuator is a piezoelectric element.

13. (canceled)
